(19) United States
(12) Patent Application Publication
(10) Pub. No.: US 2019/0235336 A1
(43) Pub. Date: Aug. 1, 2019

(54) LIQUID CRYSTAL DISPLAY DEVICE AND DISPLAY METHOD

(71) Applicant: SHARP KABUSHIKI KAISHA, Osaka (JP)

(72) Inventors: MASAKI UEHATA, Sakai City (JP); KOHJI SAITOH, Sakai City (JP); YASUKI MORI, Sakai City (JP); KAZUYA KONDOH, Sakai City (JP); KAZUHISA YOSHIMOTO, Sakai City (JP); KOSUKE KAWAMOTO, Sakai City (JP)

(21) Appl. No.: 16/262,299

(22) Filed: Jan. 30, 2019

(30) Foreign Application Priority Data
Jan. 31, 2018 (JP) 2018-015351

(51) Int. Cl. G02F 1/1362; G02F 1/1368; G02F 1/1343; G09G 3/36

(52) U.S. Cl. CPC G02F 1/136286; G02F 1/1368; G02F 1/134309; G09G 2300/0426; G09G 3/3688; G09G 2320/0209; G09G 3/3677

(57) ABSTRACT

[Problem] An object is to reduce crosstalk.

[Means for Solving the Problems] A liquid crystal display device of the present embodiment includes: a plurality of scan signal lines; a plurality of data signal lines that intersect the scan signal lines; a plurality of pixels of which each includes a switching element connecting a corresponding data signal line to a pixel electrode in a case that a scan signal of a corresponding scan signal line indicates turning-on and that are provided to correspond to combinations of the scan signal lines and the data signal lines; a common electrode that is disposed at positions facing the pixel electrodes with a liquid crystal layer interposed therebetween; a data signal line driving unit that generates output signals to the data signal lines based on display data of the pixels; a first common electrode driving unit that generates a first common electrode signal which is applied to a first area of the common electrode depending on a difference between a potential of the first area and a predetermined reference potential; and a second common electrode driving unit that generates a second common electrode signal which is applied to a second area other than the first area of the common electrode depending on a difference between a potential of the second area and the predetermined reference potential.

The present invention relates to a liquid crystal display device and a display method.

### BACKGROUND ART

With an increase in resolution of a liquid crystal display (LCD), there is a problem in that a charging period of liquid crystal (1H period) decreases and crosstalk is easily visible, for example, as illustrated in FIG. 5. FIG. 5 is a schematic diagram illustrating an example of crosstalk. In FIG. 5, a display surface 20 includes areas 20a to 20d for displaying halftone images and an area 20e for displaying a killer pattern including a bright part and a dark part. In a case that crosstalk occurs in an LCD, a boundary between the area 20a and the area 20b, a boundary between the area 20b and the area 20c, a boundary between the area 20a and the area 20d, and a boundary between the area 20d and the area 20c may be visible, for example, as indicated by broken lines.

In a case that a display pattern with a large load is displayed on an LCD, a potential of a common electrode (hereinafter also referred to as a common electrode potential) Vcom varies, for example, as illustrated in FIG. 6. In a case that the value of the common electrode potential Vcom is returned to an original value (“0”) thereof during a charging period (a 1H period), it does not affect display. However, in a case that the value of the common electrode potential Vcom is not returned to the original value, crosstalk is visible. In a case that the variation of the common electrode potential Vcom is not returned to zero during the charging period (the 1H period), a countermeasure can be taken by providing a Vcom feedback circuit (for example, see Patent Document 1). The Vcom feedback circuit is an inverting amplifier circuit, an amplification factor is determined by constants of a resistor R1 connected between an output and an inverted input and an input resistor R2 connected to the inverted input, and a resistor constant is determined such that crosstalk is not visible. Here, in a case that an amplification factor of Vcom feedback is excessively great, crosstalk may be adversely affected.

### PRIOR ART DOCUMENT

### Patent Document

[Patent Document 1] Japanese Unexamined Patent Application, First Publication No. H11-316366

### SUMMARY OF THE INVENTION

### Problem to be Solved by the Invention

As described above, with an increase in resolution of an LCD, there is a problem in that a charging period (a 1H period) of liquid crystal decreases and crosstalk is easily visible.

With an increase in resolution or an increase in screen size, in a case that only one Vcom feedback circuit is provided, Vcom feedback based on a load cannot be performed for each partial area of the whole display area. Accordingly, there is a problem in that crosstalk may be adversely affected.

The invention was made in consideration of the above-mentioned circumstances and an objective thereof is to provide a liquid crystal display device and a display method that can reduce crosstalk.

### Means for Solving the Problems

To solve the above-described problem, one aspect of the present invention is a liquid crystal display device including: a plurality of scan signal lines; a plurality of data signal lines that intersect the scan signal lines; a plurality of pixels of which each includes a switching element connecting a corresponding data signal line to a pixel electrode in a case that a scan signal of a corresponding scan signal line indicates turning-on and that are provided to correspond to combinations of the scan signal lines and the data signal lines; a common electrode that is disposed at positions facing the pixel electrodes with a liquid crystal layer interposed therebetween; a data signal line driving unit that generates output signals to the data signal lines based on display data of the pixels; a first common electrode driving unit that generates a first common electrode signal which is applied to a first area of the common electrode depending on a difference between a potential of the first area and a predetermined reference potential; and a second common electrode driving unit that generates a second common electrode signal which is applied to a second area other than the first area of the common electrode depending on a difference between a potential of the second area and the predetermined reference potential.

One aspect of the present invention is the liquid crystal display device, wherein the first area corresponds to substantially a left half area of the common electrode in a direction perpendicular to a scanning direction of the scan signal lines, and wherein the second area corresponds to substantially a right half area of the common electrode in the direction perpendicular to a scanning direction of the scan signal lines.

In addition, one aspect of the present invention is the liquid crystal display device, wherein the potential of the first area of the common electrode corresponds to potentials of a plurality of positions in the first area, and wherein the potential of the second area of the common electrode corresponds to potentials of a plurality of positions in the second area.

In addition, one aspect of the present invention is a display method in a liquid crystal display device including: a plurality of scan signal lines; a plurality of data signal lines that intersect the scan signal lines; a plurality of pixels of which each includes a switching element connecting a corresponding data signal line to a pixel electrode in a case that a scan signal of a corresponding scan signal line indicates turning-on and that are provided to correspond to combinations of the scan signal lines and the data signal lines; a common electrode that is disposed at positions facing the pixel electrodes with a liquid crystal layer interposed therebetween; a data signal line driving unit that generates output signals to the data signal lines based on display data of the pixels; a first common electrode driving unit that generates a first common electrode signal which is applied to a first area of the common electrode depending on a difference between a potential of the first area and a predetermined reference potential; and a second common electrode driving unit that generates a second common electrode signal which is applied to a second area other than the first area of the common electrode depending on a difference between a potential of the second area and the predetermined reference potential, the display method including: controlling the potential of the common electrode using the first common electrode driving unit and the second common electrode driving unit; and displaying display data on the pixels by causing the data signal line driving unit to generate the output signals based on the display data for the pixels.

### Effect of the Invention

According to the invention, since a potential which is applied to a common electrode for each area can be controlled, it is possible to easily optimize the potential for each area and to reduce crosstalk.

### BRIEF DESCRIPTION OF THE DRAWINGS

FIG. 1 is a schematic diagram illustrating an example of a configuration of a liquid crystal module according to an embodiment of the invention;

FIG. 2 is a schematic diagram illustrating an example of a configuration of a liquid crystal panel 2 illustrated in FIG. 1;

FIG. 3 is a schematic diagram illustrating an example of an operation of the liquid crystal module 1 illustrated in FIG. 1;

FIG. 4 is a schematic diagram illustrating a modified example of the liquid crystal panel 2 illustrated in FIG. 2;

FIG. 5 is a schematic diagram illustrating an example of crosstalk in an LCD; and

FIG. 6 is a diagram illustrating an example of change in potential of a common electrode in an LCD.

### EMBODIMENTS FOR CARRYING OUT THE INVENTION

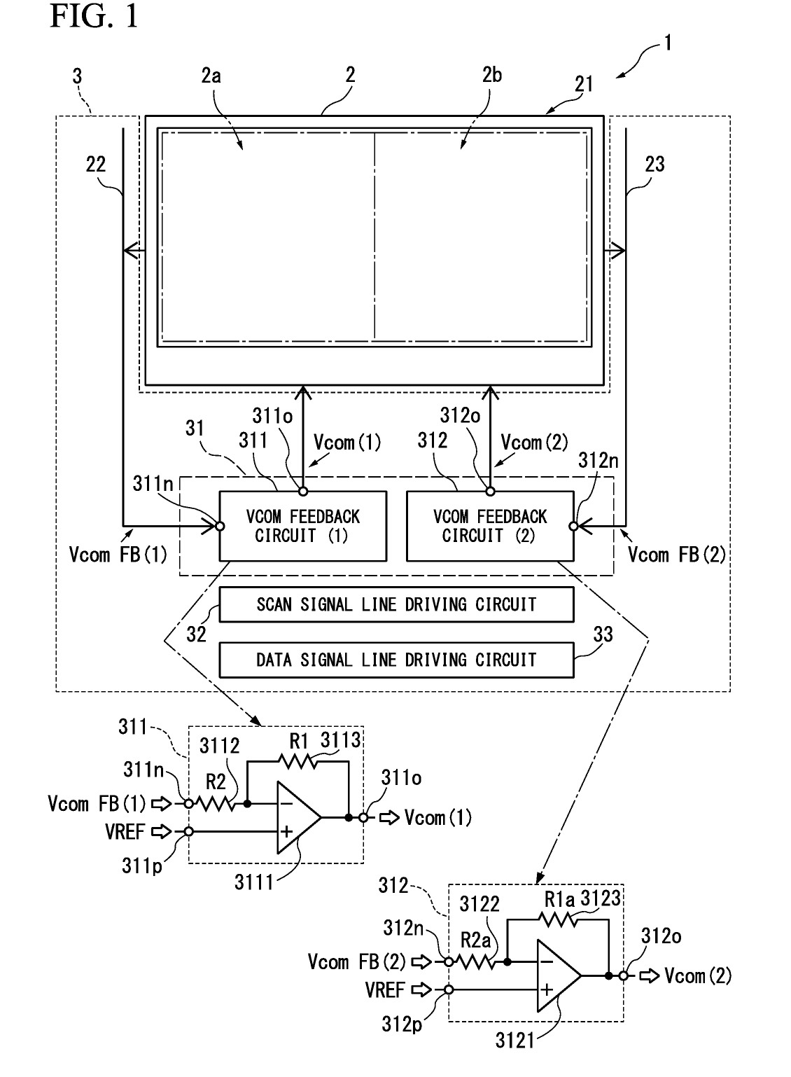

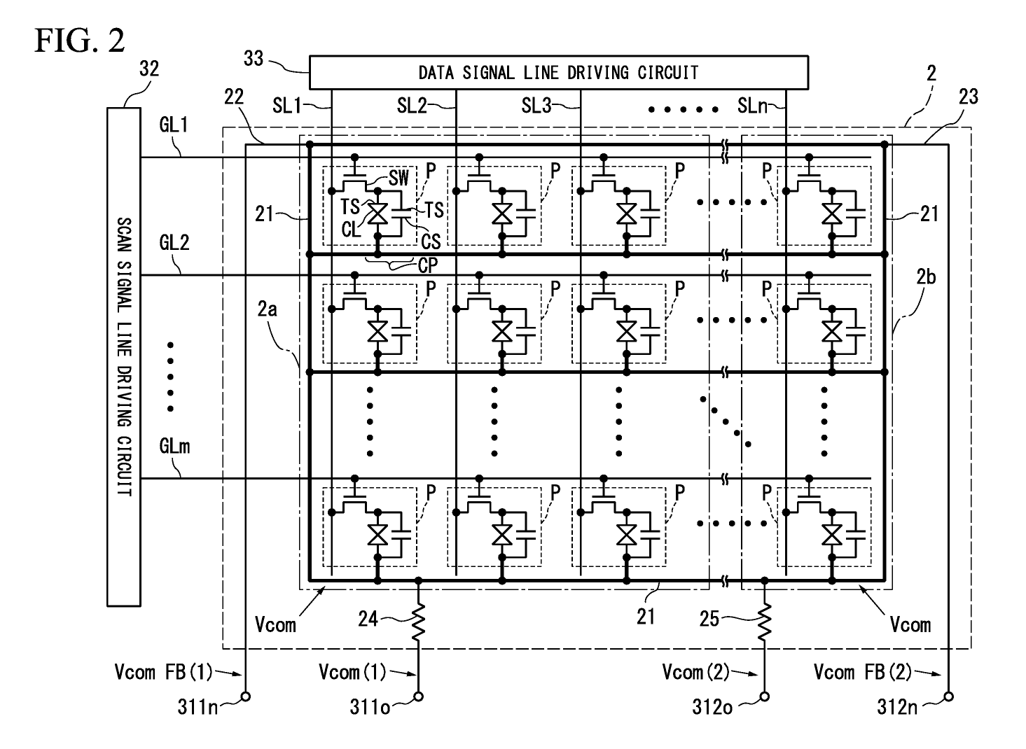

Hereinafter, an embodiment of the invention will be described with reference to the accompanying drawings. FIG. 1 is a schematic diagram illustrating an example of a configuration of a liquid crystal module 1 according to the embodiment of the invention. FIG. 2 is a schematic diagram illustrating an example of a configuration of a liquid crystal panel 2 illustrated in FIG. 1. In FIGS. 1 and 2, the same or corresponding elements will be referred to by the same reference signs.

In this specification, a liquid crystal display (LCD) is a display device using characteristics that alignment of molecules varies in a case that a voltage is applied thereto and is also referred to as a liquid crystal display device. “LCD” is a collective name for a liquid crystal panel, a liquid crystal module, a liquid crystal display device, and the like. A liquid crystal panel is an image display section of an LCD and includes, for example, a polarizing film, a color filter board, a liquid crystal layer, an array board, a polarizing film, and a backlight which are sequentially stacked from a display surface. Here, the color filter board includes a color filter and a common electrode. The array board includes wirings, a plurality of switching elements, and a plurality of pixel electrodes constituting a plurality of pixels (sub pixels). The liquid crystal module is a device in which a liquid crystal panel and a liquid crystal panel driving circuit (a drive circuit board) are combined.

As illustrated in FIG. 1, the liquid crystal module 1 according to this embodiment includes a liquid crystal panel 2 and a drive circuit board 3. The drive circuit board 3 includes a common electrode driving unit 31, a scan signal line driving circuit 32, and a data signal line driving circuit 33 (a data signal line driving unit). The common electrode driving unit 31 includes a VCOM feedback circuit (1) 311 and a VCOM feedback circuit (2) 312.

The liquid crystal panel 2 is an active matrix type liquid crystal panel, and includes a plurality of (in) scan signal lines GL1, GL2, . . . , GLm, a plurality of (n) data signal lines SL1, SL2, SL3, . . . , SLn, a plurality of (m×n) pixels P, a common electrode 21 denoted by a bold line, common electrode potential detection lines 22 and 23, and resistors 24 and 25, as illustrated in FIG. 2. In the following description, the m scan signal lines GL1, GL2, . . . , GLm are also collectively referred to as scan signal lines GL. In addition, the n data signal lines SL1, SL2, SL3, . . . , SLn are also collectively referred to as data signal lines SL. Here, the data signal lines SL are disposed to intersect the scan signal lines GL. The pixels P are provided to correspond to combinations of the scan signal lines GL and the data signal lines SL.

Each pixel P includes a field effect transistor (a switching element) SW (hereinafter referred to as a transistor SW). The gate of the transistor SW is connected to one of the scan signal lines GL. The source of the transistor SW is connected to one of the data signal lines SL. The drain of the transistor SW is connected to a pixel electrode TS. One end of a liquid crystal capacitor CL and one end of an auxiliary capacitor CS are connected to the pixel electrode TS. The other end of the liquid crystal capacitor CL and the other end of the auxiliary capacitor CS are connected to the common electrode 21. Here, the liquid crystal capacitor CL and the auxiliary capacitor CS constitute a pixel capacitor CP. The auxiliary capacitor CS may be omitted. The other end of the auxiliary capacitor may be drawn to a wire other than the common electrode 21.

In each pixel P, in a case that the corresponding scan signal line GL is selected, the transistor SW is turned on and electric charge corresponding to a difference (a voltage) between a potential applied to the corresponding data signal line SL and a potential Vcom applied to the common electrode 21 is accumulated in the pixel capacitor CP. On the other hand, in a case that a selection period of the corresponding scan signal line GL ends and the transistor SW is turned off, the pixel capacitor CP retains the voltage at the time of turning off the transistor. Here, transmittance or reflectance of liquid crystal varies depending on the voltage applied to the liquid crystal capacitor CL. Accordingly, in a case that one scan signal line GL is selected and a voltage corresponding to display data is applied to the corresponding data signal line SL, a display state of the pixel P can be changed to correspond to the display data. In a case that a scan signal of the corresponding scan signal line GL indicates turning-on, the transistor SW connects the corresponding data signal line SL to the pixel electrode TS.

The common electrode 21 is a single planar electrode and is disposed at positions facing the pixel electrodes TS with a liquid crystal layer (not illustrated) interposed therebetween. One end of the common electrode potential detection line 22 is connected to a predetermined position corresponding to a first area 2a which is surrounded by a chained line in the common electrode 21 and the other end thereof is connected to an input terminal 311n. One end of the common electrode potential detection line 23 is connected to a predetermined position corresponding to a second area 2b which is surrounded by a chained line in the common electrode 21, and the other end thereof is connected to an input terminal 312n. Here, as illustrated in FIG. 1, the first area 2a corresponds to substantially the left half area of the common electrode 21 in a direction (a horizontal direction in the drawing) perpendicular to a scanning direction (a vertical direction in the drawing) of the scan signal lines GL. As illustrated in FIG. 1, the second area 2b corresponds to substantially the right half area of the common electrode 21 in the direction perpendicular to the scanning direction of the scan signal lines GL.

The first area 2a and the second area 2b correspond to two virtual areas on the single common electrode 21. The common electrode 21 is not divided into the first area 2a and the second area 2b. Since the common electrode 21 has an in-plane resistor, there is a difference between the potential detected from the first area 2a and the potential detected from the second area 2b. By applying different voltages to the first area 2a and the second area 2b, the voltage of the first area 2a and the voltage of the second area 2b can be made to be different from each other. The first area 2a and the second area 2b may not be continuous. For example, the first area 2a may correspond to a partial area around the left end of the common electrode 21, and the second area 2b may correspond to a partial area around the right end of the common electrode 21.

The scan signal line driving circuit 32 sequentially scans the scan signal lines GL and outputs a predetermined scan signal. The data signal line driving circuit 33 outputs data signals corresponding to display data of the pixels P to the pixels P which are selected by causing the scan signal line driving circuit 32 to output the predetermined scan signal.

In the liquid crystal panel 2, in a case that the scan signal line driving circuit 32 selects a certain scan signal line GL, the transistors SW in the pixels P connected to the corresponding scan signal line GL are turned on to connect the pixel electrodes TS to the corresponding data signal lines SL. On the other hand, the data signal line driving circuit 33 outputs display data for the pixels P to the data signal lines SL based on a predetermined image signal. Electric charge corresponding to a potential difference between the output of the corresponding data signal line SL and the potential Vcom of the common electrode 21 is accumulated in the pixel capacitor CP of each pixel P. In the pixels P connected to the non-selected scan signal lines GL, the transistors SW are turned on and electric charge of the pixel capacitors CP are retained. Transmittance of a liquid crystal element varies depending on an applied voltage. Accordingly, by writing display data to the pixels P during a selection period of each scan signal line GL while sequentially selecting the scan signal lines GL, the liquid crystal panel 2 displays an image corresponding to an image signal.

On the other hand, the VCOM feedback circuit (1) 311 illustrated in FIG. 1 includes an operational amplifier 3111, a resistor 3112, and a resistor 3113. An inverted input of the operational amplifier 3111 is connected to one end of the resistor 3112 and one end of the resistor 3113. The other end of the resistor 3112 is connected to an input terminal 311n of the VCOM feedback circuit (1) 311. The other end of the resistor 3113 is connected to an output of the operational amplifier 3111 and an output terminal 3110 of the VCOM feedback circuit (1) 311. A non-inverted input of the operational amplifier 3111 is connected to an input terminal 311p of the VCOM feedback circuit (1) 311. In this case, the resistance value of the resistor 3112 is defined as R2, and the resistance value of the resistor 3113 is defined as R1. A predetermined reference potential VREF is applied to the input terminal 311p. The reference potential VREF corresponds to a target value of the potential of the common electrode 21. The input terminal 311n is connected to the common electrode potential detection line 22. The output terminal 3110 is connected to one end of a resistor 24 illustrated in FIG. 2.

According to this configuration, the VCOM feedback circuit (1) 311 changes the potential Vcom(1) of an output signal output from the output terminal 3110 based on a difference between the reference potential VREF and the potential Vcom FB(1) of the common electrode potential detection line 22 such that the difference decreases.

An amplification factor which is a ratio of the magnitude of the output signal to the magnitude of the difference is determined as a value of a ratio of the resistance value R2 and the resistance value R1. That is, the VCOM feedback circuit (1) 311 (a first common electrode driving unit) generates and outputs an output signal (a first common electrode signal) of the potential Vcom(1) which is applied to the first area 2a based on the difference between the potential VCOM FB(1) corresponding to the first area 2a of the common electrode 21 and the predetermined reference potential VREF.

The VCOM feedback circuit (2) 312 includes an operational amplifier 3121, a resistor 3122, and a resistor 3123. An inverted input of the operational amplifier 3121 is connected to one end of the resistor 3122 and one end of the resistor 3123. The other end of the resistor 3122 is connected to an input terminal 312n of the VCOM feedback circuit (2) 312. The other end of the resistor 3123 is connected to an output of the operational amplifier 3121 and an output terminal 312o of the VCOM feedback circuit (2) 312. A non-inverted input of the operational amplifier 3121 is connected to an input terminal 312p of the VCOM feedback circuit (2) 312. In this case, the resistance value of the resistor 3122 is defined as R2a, and the resistance value of the resistor 3123 is defined as R1a. The resistance value R1a may be equal to or different from the resistance value R1. The resistance value R2a may be equal to or different from the resistance value R2. A predetermined reference potential VREF is applied to the input terminal 312p. The reference potential VREF corresponds to a target value of the potential of the common electrode 21. The input terminal 312n is connected to the common electrode potential detection line 23. The output terminal 312o is connected to one end of a resistor 25 illustrated in FIG. 2.

According to this configuration, the VCOM feedback circuit (2) 312 changes the potential Vcom(2) of an output signal output from the output terminal 312o based on a difference between the reference potential VREF and the potential Vcom FB(2) of the common electrode potential detection line 23 such that the difference decreases.

An amplification factor which is a ratio of the magnitude of the output signal to the magnitude of the difference is determined as a value of a ratio of the resistance value R2a and the resistance value R1a. That is, the VCOM feedback circuit (2) 312 (a second common electrode driving unit) generates and outputs an output signal (a second common electrode signal) of the potential Vcom(2) which is applied to the second area 2b on based on the difference between the potential VCOM FB(2) corresponding to the second area 2b of the common electrode 21 and the predetermined reference potential VREF.

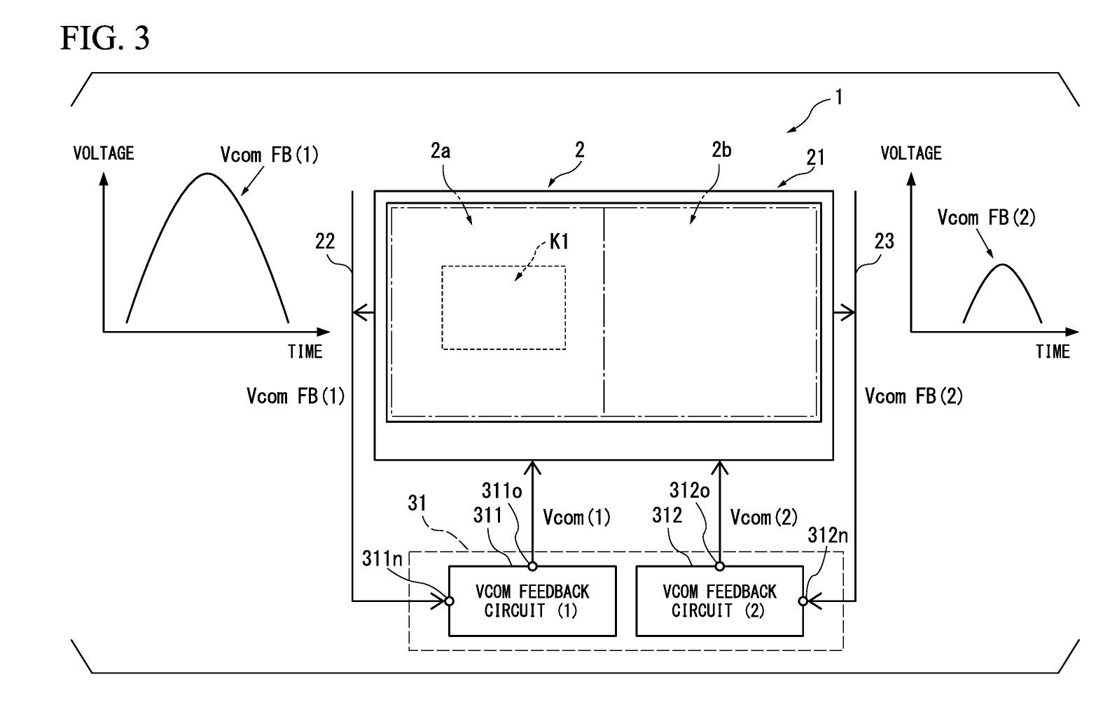

An operation example (a display example) of the liquid crystal module 1 which has been described above with reference to FIGS. 1 and 2 will be described below with reference to FIG. 3. In the example illustrated in FIG. 3, a killer pattern K1 is included in the first area 2a of the liquid crystal module 1, and a killer pattern is not included in the second area 2b.

FIG. 3 schematically illustrates an example of change of the absolute value of the potential Vcom FB(1) of the first area 2a of the common electrode 21 and change of the absolute value of the potential Vcom FB(2) of the second area 2b of the common electrode 21 in one frame period. In this case, as illustrated in FIG. 3, the absolute value of the potential Vcom FB(1) of the first area 2a of the common electrode 21 changes relatively great, but the absolute value of the potential Vcom FB(2) of the second area 2b of the common electrode 21 changes relatively small. On the other hand, the VCOM feedback circuit (1) 311 generates an output signal with a potential Vcom(1) based on the difference between the potential VCOM FB(1) and the reference potential VREF and applies the generated output signal to the first area 2a. The VCOM feedback circuit (2) 312 generates an output signal with a potential Vcom(2) based on the difference between the potential VCOM FB(2) and the reference potential VREF and applies the generated output signal to the second area 2b. That is, in this embodiment, feedback control of the potential Vcom of the common electrode 21 is performed separately on the right and left areas of the liquid crystal panel 2 by the VCOM feedback circuit (1) 311 and the VCOM feedback circuit (2) 312. Accordingly, according to this configuration, it is possible to apply optimal Vcom feedback for each display position and to reduce crosstalk.

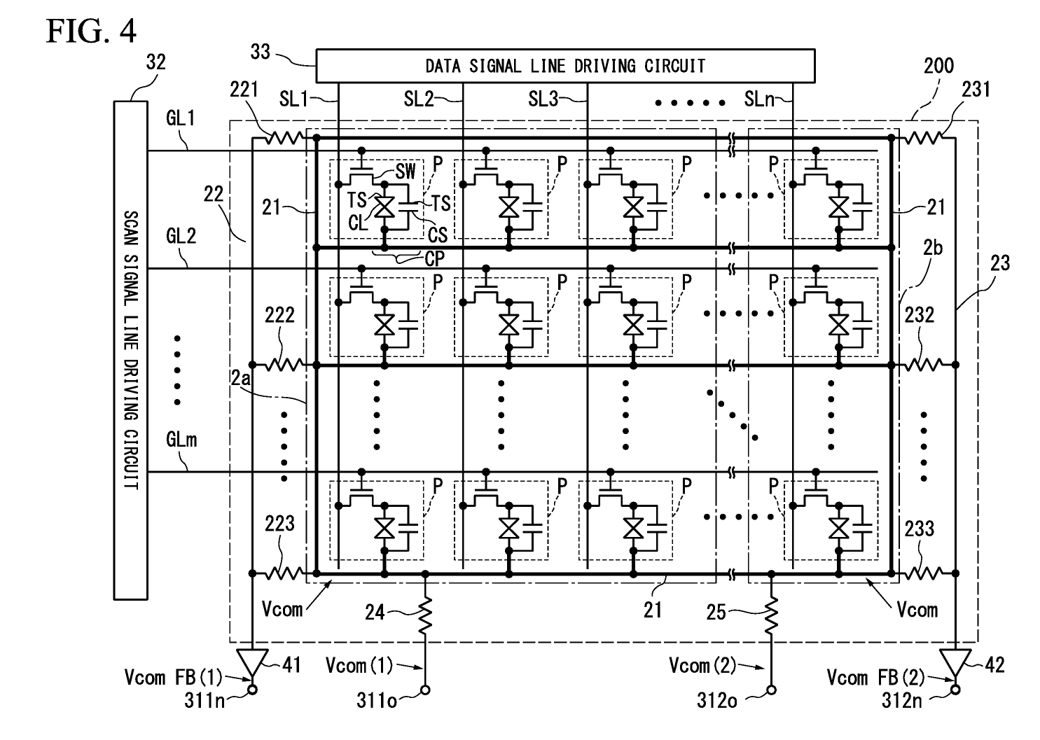

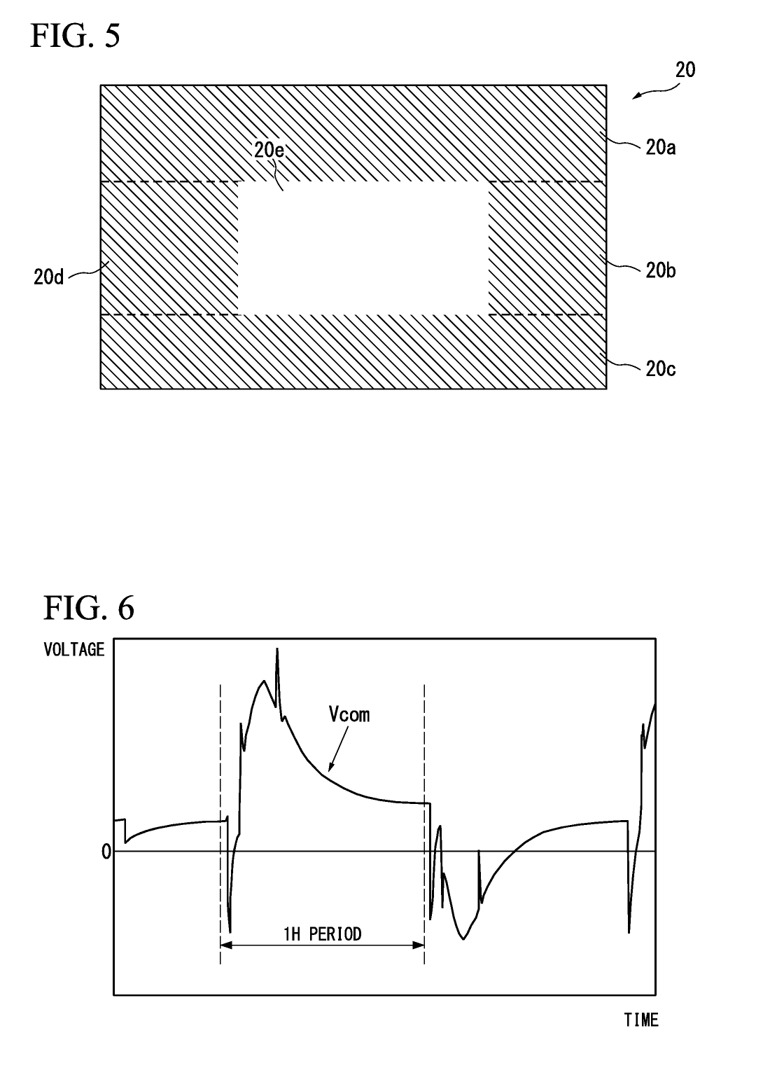

A modified example of the liquid crystal panel 2 illustrated in FIG. 2 will be described below with reference to FIG. 4. In FIG. 4, the same or corresponding elements as the elements illustrated in FIG. 2 will be referred to by the same reference signs and description thereof will be appropriately omitted.

A liquid crystal panel 200 illustrated in FIG. 4 is different from the liquid crystal panel 2 illustrated in FIG. 2 in the following points.

That is, in the liquid crystal panel 2 illustrated in FIG. 2, the common electrode potential detection line 22 is connected directly to the input terminal 311n and the common electrode 21. On the other hand, in the liquid crystal panel 200 illustrated in FIG. 4, the common electrode potential detection line 22 is connected to the input terminal 311n via a voltage follower circuit 41 and is connected to a plurality of positions of the first area 2a of the common electrode 21 via a plurality of resistors 221, 222, 223, and the like. In the liquid crystal panel 200, the common electrode potential detection line 23 is connected to the input terminal 312n via a voltage follower circuit 42 and is connected to a plurality of positions of the second area 2b of the common electrode 21 via a plurality of resistors 231, 232, 233, and the like. For example, in a case that the plurality of resistors 221, 222, 223, and the like have the same resistance value, the voltage follower circuit 41 averages the potentials at a plurality of positions of the first area 2a of the common electrode 21 to which the plurality of resistors 221, 222, 223, and the like are connected and outputs the average potential as the potential Vcom FB(1). For example, in a case that the plurality of resistors 231, 232, 233, and the like have the same resistance value, the voltage follower circuit 42 averages the potentials at a plurality of positions of the second area 2b of the common electrode 21 to which the plurality of resistors 231, 232, 233, and the like are connected and outputs the average potential as the potential Vcom FB(2).

In the liquid crystal panel 200 illustrated in FIG. 4, the potential Vcom(1) which is applied to the first area 2a can be controlled based on the potentials at a plurality of positions of the first area 2a of the common electrode 21. The potential Vcom(2) which is applied to the second area 2b can be controlled based on the potentials at a plurality of positions of the second area 2b of the common electrode 21.

As described above, according to the embodiment of the invention and the modified example, a plurality of VCOM feedback circuits are provided on the drive circuit board 3 of the liquid crystal module 1. Accordingly, according to this embodiment, it is possible to optimally set the potential of the common electrode for each display area of the liquid crystal panel 2 and to make it difficult to make crosstalk visible on the entire surfaces of the display areas.

In the above description, the embodiment of the invention is applied to a liquid crystal module, but the embodiment of the invention may be applied to, for example, a notebook personal computer in which the liquid crystal module according to the embodiment is mounted or a monitor in which the liquid crystal module according to the embodiment is mounted.

In the above-mentioned embodiment, the liquid crystal panel 2 is partitioned into two areas and feedback control of the common electrode is performed for each area, but the number of areas is not limited to two and three or more areas may be used. In this case, three or more Vcom feedback circuits are provided.

In the above-mentioned embodiment, the output of the VCOM feedback circuit (1) 311 is applied to the common electrode 21 via the single resistor 24, but for example, a plurality of resistors may be connected to the output terminal 3110 of the VCOM feedback circuit (1) 311 and the output of the VCOM feedback circuit (1) 311 may be applied to a plurality of positions of the first area 2a of the common electrode 21 via the resistors. Similarly, a plurality of resistors may be connected to the output terminal 312o of the VCOM feedback circuit (2) 312 and the output of the VCOM feedback circuit (2) 312 may be applied to a plurality of positions of the second area 2b of the common electrode 21 via the resistors. The positions from which the potential is detected in the common electrode 21 are not limited to the right and left ends of the liquid crystal panel 2, and, for example, upper and lower ends may be used as the detection positions or positions other than the ends may be used as the detection positions.

The method of driving the pixels P may be a common symmetry method or may be a common inversion method.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims

### DESCRIPTION OF THE REFERENCE SYMBOLS

1 Liquid crystal module
2 Liquid crystal panel
3 Drive circuit board
21 Common electrode
31 Common electrode driving unit
32 Scan signal line driving circuit
33 Data signal line driving circuit (data signal line driving unit)
311 VCOM feedback circuit (1)
312 VCOM feedback circuit (2)
P Pixel
SW Field effect transistor
GL1, GL2, . . . , GLm Scan signal line
SL1, SL2, SL3, . . . , SLn Data signal line
TS Pixel electrode

1. A liquid crystal display device comprising:
a plurality of scan signal lines;
a plurality of data signal lines that intersect the scan signal lines;
a plurality of pixels of which each includes a switching element connecting a corresponding data signal line to a pixel electrode in a case that a scan signal of a corresponding scan signal line indicates turning-on and that are provided to correspond to combinations of the scan signal lines and the data signal lines;
a common electrode that is disposed at positions facing the pixel electrodes with a liquid crystal layer interposed therebetween;
a data signal line driving unit that generates output signals to the data signal lines based on display data of the pixels;
a first common electrode driving unit that generates a first common electrode signal which is applied to a first area of the common electrode depending on a difference between a potential of the first area and a predetermined reference potential; and
a second common electrode driving unit that generates a second common electrode signal which is applied to a second area other than the first area of the common electrode depending on a difference between a potential of the second area and the predetermined reference potential.

2. The liquid crystal display device according to claim 1, wherein the first area corresponds to substantially a left half area of the common electrode in a direction perpendicular to a scanning direction of the scan signal lines, and
wherein the second area corresponds to substantially a right half area of the common electrode in the direction perpendicular to a scanning direction of the scan signal lines.

3. The liquid crystal display device according to claim 1, wherein the potential of the first area of the common electrode corresponds to potentials of a plurality of positions in the first area, and
wherein the potential of the second area of the common electrode corresponds to potentials of a plurality of positions in the second area.

4. A display method in a liquid crystal display device including:
a plurality of scan signal lines;
a plurality of data signal lines that intersect the scan signal lines;
a plurality of pixels of which each includes a switching element connecting a corresponding data signal line to a pixel electrode in a case that a scan signal of a corresponding scan signal line indicates turning-on and that are provided to correspond to combinations of the scan signal lines and the data signal lines;
a common electrode that is disposed at positions facing the pixel electrodes with a liquid crystal layer interposed therebetween;
a data signal line driving unit that generates output signals to the data signal lines based on display data of the pixels;
a first common electrode driving unit that generates a first common electrode signal which is applied to a first area of the common electrode depending on a difference between a potential of the first area and a predetermined reference potential; and
a second common electrode driving unit that generates a second common electrode signal which is applied to a second area other than the first area of the common electrode depending on a difference between a potential of the second area and the predetermined reference potential,
the display method comprising:
controlling the potential of the common electrode using the first common electrode driving unit and the second common electrode driving unit; and
displaying display data on the pixels by causing the data signal line driving unit to generate the output signals based on the display data for the pixels.
